(19) United States
(12) Patent Application Publication
(10) Pub. No.: US 2020/0015450 A1
(43) Pub. Date: Jan. 16, 2020

(54) FEED TRUCK CONTROL MODULE

(71) Applicant: MWI Veterinary Supply Co., Amarillo, TX (US)

(72) Inventors: Joe Young, Amarillo, TX (US); Wade Johnson, Amarillo, TX (US); Marcus Dorsey, Amarillo, TX (US); John Longoria, Amarillo, TX (US); Tim Peart, Amarillo, TX (US)

(73) Assignee: MWI Veterinary Supply Co., Amarillo, TX (US)

(21) Appl. No.: 16/505,517

(22) Filed: Jul. 8, 2019

Related U.S. Application Data
(60) Provisional application No. 62/697,307, filed on Jul. 12, 2018.

(51) Int. Cl. A01K 5/02; G05B 19/4155

(52) U.S. Cl. CPC A01K 5/0275; G05B 2219/35123; G05B 19/4155

(57) ABSTRACT

A system for dispensing feed to a feed bunk can include a dispensing unit and a control module. The dispensing unit can include a feed container to receive feed, and one or more dispensing devices operatively coupled to the feed container. The control module can be in communication with the dispensing unit and configured to receive and store sequence data from a central computer system, the sequence data comprising a delivery sequence according to which one or more feed bunks are to be filled, and one or more system inputs. The control module is configured to disable the dispensing unit if any system input does not correspond to the sequence data.

### RELATED APPLICATIONS

This application claims the benefit of U.S. Provisional Application No. 62/697,307, filed on Jul. 12, 2018, which is incorporated herein by reference.

### FIELD

This disclosure concerns embodiments of a system and method for distributing feed rations to livestock animals (e.g., cattle, swine, poultry, etc.) using a feed truck.

### BACKGROUND

Feed lots feed livestock (e.g., cattle) contained in pens, each pen typically comprising a feed bunk or trough into which the feed is dispensed. While the livestock within a particular pen are generally fed the same feed ration (e.g., the same type and quantity of feed, and the same feed additives), a feed lot typically comprises a variety of pens that house cattle at various stages of growth and health. As such, each pen within a feed lot may require a unique feed ration.

Administering a feed ration typically includes loading a feed truck with feed rations, driving the feed truck to a specified feed bunk, dispensing a feed ration into the feed bunk, proceeding to the next feed bunk, dispensing the proceeding feed ration, and repeating the process of driving and dispensing until each pen has been filled and/or the feed rations in the truck have run out.

Due to the large number of pens and the differing feed rations required for each pen, pen sequence and ration type must be monitored carefully to ensure that the correct type and quantity of ration is being delivered to the correct pen. It is the operator's responsibility to determine that the feed bunk has received the proper type and amount of feed. However, operators are prone to human error. Some prior art systems have attempted to remedy this problem by using an alert system to alert an operator who is at an incorrect pen or when an incorrect quantity of feed has been distributed. However, these alerts may be ignored or overridden by the operator, who may choose to dispense feed to the pen anyway.

Thus, a need exists to address these and other issues associated with feed dispensation.

### SUMMARY

The present disclosure concerns embodiments of a system for dispensing feed rations comprising a control module and a feed dispensing unit, and embodiments of a method for using the system to dispense feed that addresses problems associated with known methods and devices. Disclosed embodiments of the system and method increase accuracy in dispensing feed rations to the correct feed bunk and/or increase accuracy in dispensing feed ration quantity.

In a representative embodiment, a system for dispensing feed to a feed bunk comprises a control module and a delivery apparatus. The control module can communicate with the dispensing unit and can be operatively configured to disable the dispensing unit from dispensing feed. The dispensing unit can comprise a feed container and one or more dispensing devices configured to dispense feed from the feed container. The control module can be configured to receive and store sequence data from a central computer system and one or more system inputs.

The sequence data can comprise information useful for accurately dispensing feed rations. For example, in some embodiments, sequence data comprises a delivery sequence in which one or more feed bunks are to be filled, a target quantity of feed for each feed bunk, a target ration type for each feed bunk, or any combination thereof. The system inputs can comprise, for example, location data to identify the dispensing unit location, feed bunk identification data identifying one or more feed bunks, quantity data identifying a quantity of feed within the dispensing unit, ration type data for feed in the feed container, or any combination thereof.

The dispensing unit can further comprise a quantity indicator configured to measure a quantity of feed within the feed container.

The control module can be configured to compare the sequence data to the one or more system inputs and to disable the dispensing unit if the one or more system inputs do not correspond to the sequence data.

In another representative embodiment, a system for dispensing feed comprises a dispensing unit and a control module. The dispensing unit comprises a feed container and one or more dispensing devices. The feed container can contain a feed ration and the one or more dispensing devices can be operatively coupled to the feed container to dispense feed from the feed container. The control module can be in communication with the dispensing unit and can be configured to receive and store sequence data from a central computer system and one or more system inputs. The sequence data can comprise a delivery sequence according to which one or more feed bunks are to be filled. The system inputs can comprise, for example, location data identifying the location of the dispensing unit and feed bunk identification data for the one or more feed bunks. The control module can be configured to disable the dispensing unit if any system input does not correspond to the sequence data.

The control module can receive location data and feed bunk identification data from a GPS unit in communication with the control module. In some embodiments, the dispensing unit can further comprise a quantity indicator operatively coupled to the feed container. An additional system input can comprise quantity data from the quantity indicator. In some embodiments, an additional system input can comprise ration type data identifying a type of feed ration in the feed container.

In another representative embodiment, a system for dispensing feed comprises a dispensing unit. The dispensing unit can comprise: (i) a feed container to receive feed; (ii) one or more dispensing devices operatively coupled to the feed container to dispense feed from the feed container; (iii) a quantity indicator operatively coupled to the feed container to measure the quantity of feed within the feed container and provide quantity data; (iv) a location unit to determine a location of the dispensing unit and provide location data; (v) a speed indicator to determine the dispensing unit speed and provide speed data; (vi) a gate operatively coupled to the feed container, the gate having a gate position movable between an open position wherein feed can be distributed and a closed position to prevent feed distribution; and/or (vii) a gate position indicator operatively coupled to the gate to provide gate position data.

The system further comprises a control module in communication with the dispensing unit. The control module can be configured to receive and store sequence data from a central computer system, the sequence data comprising: (a) a delivery sequence in which one or more feed bunks are to be filled; (b) a target quantity of feed for each of the one or more feed bunks; and (c) a ration type for each of the one or more feed bunks. The control module can further be configured to receive and store one or more system inputs, the system inputs comprising: (a) location data; (b) feed bunk identification data for one or more feed bunks; (c) quantity data; (d) ration type data for feed in the feed container; (e) speed data for the dispensing unit; and (f) gate position data. Additionally, the control module can transmit the system inputs in real-time to the central computer system, control the gate position and speed based on the system inputs, activate the one or more dispensing devices if the system inputs correspond to the sequence data, and disable the dispensing devices if system inputs do not correspond to the sequence data.

The present disclosure also includes a method comprising providing any embodiment of the system as described herein, and using the system. In some embodiments, using the system can comprise receiving and storing, using a control module in communication with a dispensing unit, sequence data from a central computer system. The sequence data can comprise a target delivery sequence in which one or more feed bunks are to be filled, a target quantity of feed for each of the one or more feed bunks, and a target ration type for each of the one or more feed bunks. The method can further comprise receiving and storing, using the control module, one or more system inputs. The system inputs can comprise quantity data and ration-type data for feed in the dispensing unit. The method can further comprise advancing the dispensing unit to a feed bunk and receiving, using the control module, additional system inputs. The additional system inputs can comprise location data identifying the dispensing unit location and feed bunk identification data for the feed bunk. The method can further comprise comparing, using the control module, the system inputs to the sequence data and disabling, using the control module, the dispensing unit if the system inputs do not correspond to the sequence data.

In some embodiments, the dispensing unit may be disabled.

In some embodiments, the method can further comprise dispensing a feed ration to the feed bunk if the system inputs correspond to the sequence data.

In some embodiments, the method can further comprise receiving, using the control module, additional system inputs comprising dispensing unit speed data and gate position data for a dispensing unit gate and controlling, using the control module, a gate position based on the system inputs.

In some embodiments, the method can further comprise controlling, using the control module, a dispensing unit location and dispensing unit speed and dispensing a first feed ration to the feed bunk if the system inputs correspond to the sequence data.

In some embodiments, the method can further comprise repeating the acts of: advancing the dispensing unit to a feed bunk; receiving, using the control module, system inputs comprising dispensing unit location data and identifying data for the feed bunk; comparing, using the control module, system inputs to the sequence data; and disabling, using the control module, the dispensing unit if the system inputs do not correspond to the sequence data.

In some embodiments, the method can further comprise manually entering a manual feed bunk identification into the control module; comparing, using the control module, the manual feed bunk identification to the sequence data; and disabling, using the control module, the dispensing unit if the manual feed bunk identification does not correspond to the sequence data.

The present disclosure also includes a method for making disclosed embodiments of the system. In a representative embodiment, a method can comprise making a system according to any of the system embodiments described herein.

The foregoing and other objects, features, and advantages of the invention will become more apparent from the following detailed description, which proceeds with reference to the accompanying figures.

### BRIEF DESCRIPTION OF THE DRAWINGS

FIG. 1 is a schematic diagram of an exemplary embodiment of a system for dispensing feed.

FIG. 2 is a representative diagram of an exemplary computing environment.

FIG. 3 is a flow diagram of an exemplary method for dispensing feed using the system of FIG. 1.

FIG. 4 is a flow diagram of an exemplary method for dispensing feed using the system of FIG. 1.

FIG. 5 is a flow diagram of an exemplary method for calculating a quantity of feed to be dispensed to a feed bunk and dispensing the calculated quantity of feed using the system of FIG. 1.

FIG. 6 is a flow diagram of an exemplary method for dispensing feed using the system of FIG. 1.

### DETAILED DESCRIPTION

### I. Definitions and Abbreviations

The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise. Additionally, the term “includes” means “comprises.” Further, the terms “coupled” and “associated” generally mean electrically, electromagnetically, and/or physically (e.g., mechanically or chemically) coupled or linked and does not exclude the presence of intermediate elements between the coupled or associated items absent specific contrary language.

Unless explained otherwise, all technical and scientific terms used herein have the same meaning as commonly understood to one of ordinary skill in the art to which this disclosure pertains. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims.

In the following description, certain terms may be used such as “up,” “down,” “upper,” “lower,” “horizontal,” “vertical,” “left,” “right,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

Unless otherwise indicated, all numbers expressing quantities as used in the specification or claims are to be understood as being modified by the term “about.” Accordingly, unless otherwise implicitly or explicitly indicated, or unless the context if properly understood by a person of ordinary skill in the art to have a more definitive construction, the numerical parameters set forth are approximations that may depend on the desired properties sought and/or limits of detection under standard test conditions/methods as known to those of ordinary skill in the art. When directly and explicitly distinguishing embodiments from discussed prior art, the embodiment numbers are not approximates unless the word “about” is recited.

In order to facilitate review of the various embodiments of the disclosure, the following explanations of specific terms are provided:

Bluetooth® device: An ultra-high frequency radio wave transceiver that transmits and receives radio waves within a frequency band of from 2.4 to 2.485 GHz.

Feed Animal: Includes animal species raised for human consumption, particularly ruminants, swine, and poultry.

Feed ration: Anything that may be consumed by an animal, including both solids and liquids and including, without limitation grain, soy, hay, grass, silage, and legumes.

Feed Additive: Anything that is added to animal feed including, without limitation, nutritional supplements, antibiotics, therapeutics, proteins, enzymes, vitamins, amino acids, and combinations thereof.

Ruminant: Includes bovine, sheep, goat, deer, bison, buffalo, elk, llama, alpaca, and antelope.

Swine: Includes pigs, sows, gilts, piglets, and boar.

Poultry: Includes chicken, turkey, goose, duck, Cornish game hen, quail, partridge, pheasant, guinea-fowl, ostrich, emu, swan, and pigeon.

Transceiver: A dual-purpose receiver and transmitter device.

TW: Target weight; the scale weight at which the desired quantity will have been dispensed.

UI: User interface; the UI can be shown on the display.

Wi-Fi® device: A wireless transceiver that transmits and receives radio waves within a frequency band of 2.4 GHz or 5 GHz.

Although the operations of some of the disclosed embodiments are described in a particular, sequential order for convenient presentation, it should be understood that this manner of description encompasses rearrangement, unless a particular order is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one of ordinary skill in the art.

### II. System for Dispensing Feed

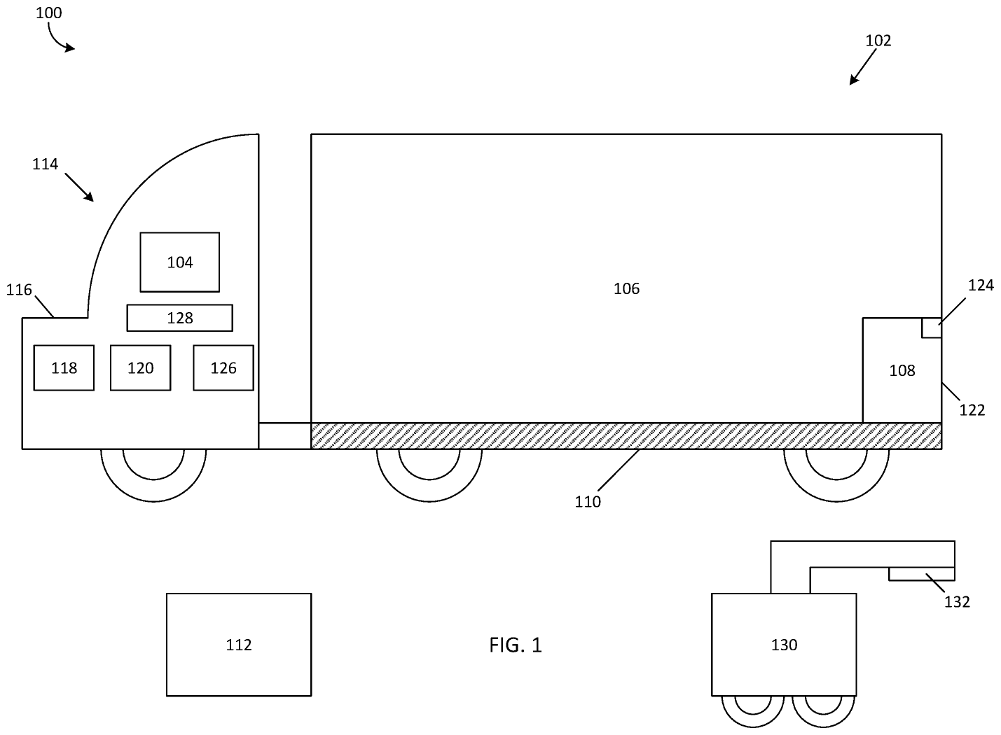

Embodiments of the disclosed system are useful for dispensing feed rations using a dispensing unit and a control module to ensure that the correct feed ration is dispensed to the correct feed bunk. FIG. 1 concerns a representative system 100 comprising a dispensing unit 102 and a control module 104. The dispensing unit 102 can comprise a feed container 106, one or more dispensing devices 108 (e.g., one in the illustrated embodiment), and a quantity indicator 110. The control module 104 communicates with the dispensing unit 102 and can be configured to transmit and receive one or more data inputs identifying various system parameters (i.e., system inputs). In some embodiments, system 100 further comprises a central computer system 112 in communication with the control module 104. In some embodiments, system 100 further comprises a scanning unit configured to receive and/or transmit one or more system inputs to the control module 104 and/or the central computer system 112, as described in more detail below.

The term “system inputs” as used herein comprises individual data points, sets of data points, sequences, calculated amounts, etc. Some system inputs can be system-wide inputs, meaning that they remain the same for each feed bunk throughout a selected delivery sequence. For example, the delivery sequence, climate data, and ration type data can be system-wide inputs. Other system inputs can be local inputs, meaning that they vary for each feed bunk. For example, feed bunk level data, feed animal type data, feed animal weight data, aggressiveness data, dwell time data, and history data can be local inputs that vary for each feed bunk. In some embodiments, when the dispensing unit 102 reaches a selected feed bunk, the local inputs for the selected feed bunk can be provided to the control module 104 from the scanning unit 130 and/or the central computer system 112.

In the illustrated embodiment, the system 100 is installed on a feed truck 114 comprising a cab 116. A user can operate system 100 from the cab. In other embodiments, the system 100 can be installed on other vehicle types. In still other embodiments, particularly in autonomously driving embodiments, the cab 116 may be optional.

Referring still to FIG. 1, the feed container 106 of the dispensing unit 102 can receive and store a feed ration. The feed container 106 can be operatively connected to a quantity indicator 110 configured to determine a quantity of feed within the feed container. The quantity indicator 110 can determine the weight, volume, mass, and/or density of the feed and can transmit data, for example, real-time quantity data to the control module 104. In a particular example, quantity indicator 110 can be a load cell configured to determine the weight of feed within the feed container. In embodiments wherein the quantity indicator is a load cell, the load cell can be a strain gauge load cell, a pneumatic load cell, a hydraulic load cell, or other load cell configured to determine the weight of feed within the feed container.

The quantity indicator 110 can be used to determine and provide the quantity of feed dispensed by subtractive measurement. For example, a feed bunk can have a target quantity of feed to be distributed thereto (e.g., as specified by the sequence data). Upon loading the feed container 106 with feed and/or prior to beginning to dispense feed at each new feed bunk, a starting amount of feed within the container 106 can be determined using the quantity indicator 110. As feed is dispensed, the quantity indicator provides a current amount of feed in real time to the control module 104. The quantity of feed dispensed is calculated by subtracting the current amount from the starting amount. The control module 104 can be configured to receive quantity data comprising the first and second amounts and use the quantity data to calculate the amount of feed dispensed to each feed bunk.

As mentioned above, in some embodiments, the amount of feed can be determined by weight and the quantity indicator can be, for example, a load cell, a scale, or other weighing device. In other embodiments, the amount of feed can be determined by volume and the quantity indicator can be, for example, a set of measurement indicia on the feed container, a device that measures the flow rate of feed into and/or out of the feed container, or other volume determining device.

The feed container 106 can be operatively coupled to the dispensing device 108. In some embodiments, the feed container can comprise an angled or sloped floor to facilitate movement of feed into the dispensing device 108. Dispensing device 108 is configured to dispense feed from the feed container 106 to a selected feed bunk. In some embodiments, the dispensing device 108 can comprise one or more augers. In other embodiments, the dispensing device can comprise one or more rotary valves. In still other embodiments, the dispensing device 108 can be a slide or ramp angled to allow feed to slide from the feed container 106 down the ramp and into the selected feed bunk.

The system 100 can further comprise a location unit 118 configured to determine and provide location data comprising a location of the dispensing unit 102. In some embodiments, the location unit 118 can be a GPS unit. In other embodiments, the location unit can be a radio-frequency identification (RFID) reader unit. In some embodiments, the location unit 118 can be operatively coupled to the dispensing unit 102 and can receive and transmit location data to the control module 104. In other embodiments, the location unit 118 can be integrally formed with the control module 102. Any and all combinations of these dispensing devices can also be used.

The system 100 can further comprise a speed indicator 120 configured to determine and provide speed data comprising the travel speed of the dispensing unit. The speed indicator 120 can transmit the speed data to the control module 104. The speed indicator 120 can be, for example, a speedometer, a radar gun, a LIDAR speed gun, etc., or combinations thereof.

In some embodiments, the dispensing unit 102 further comprises a metering device, for example gate 122, operatively coupled to the feed container 106 for metering the movement of feed from the feed container 106 into a feed bunk. The gate 122 can be movable between an open position, wherein feed can move from the feed container 106 into a feed bunk, and a closed position, wherein feed is prevented from moving into a feed bunk. The gate 122 can be positioned at any location between and including the open and closed positions. For example, during movement of the dispensing unit 108 from one feed bunk to another, the gate can be in the closed position. Once the dispensing unit 102 has reached a selected feed bunk, the gate 122 may be opened, allowing the dispensing devices 108 of the dispensing unit 102 to distribute feed to the selected feed bunk. The position of the gate between a closed and an open position can be used regulate the speed at which feed can move from the feed container 106 to the feed bunk, thus regulating the rate of feed distribution to the feed bunk in combination with other factors, for example, the speed of the dispensing unit 102. In some embodiments wherein the dispensing devices 108 comprise rotational devices such as augers or rotary valves, regulating the rate of feed distribution can further comprise adjusting the rate of rotation of the dispensing devices 108.

The system 100 can further comprise a gate position indicator 124, configured to measure a position of the metering device or gate 122 and to control the position of the gate 122. The gate position indicator 124 can transmit data, for example, gate position data to the control module 104.

Referring still to FIG. 1, system 100 may comprise a central computer system 112. The central computer system is configured to transmit and receive data from the control module 104. For example, the central computer system 112 can transmit sequence data to the control module. The sequence data can comprise one or more system inputs. The system inputs can be system-wide inputs and/or local inputs. For example, the sequence data can comprise: (i) a delivery sequence in which the one or more feed bunks are to be filled; (ii) a target quantity of feed to be dispensed to each feed bunk; and (iii) a target ration type for each feed bunk.

In some embodiments, the target quantity of feed to be dispensed to each feed bunk can be an amount calculated via algorithm, as described in more detail below.

In some embodiments, the target ration type can be selected based at least in part on the amount of time a selected set of feed animals has been in a selected pen (the dwell time). Ration types can include, for example, high-energy ration, maintenance rations, etc. A ration type need not be limited to one specific type of feed, but rather can comprise combinations of two or more types of feed. For example, a high-energy ration can comprise corn and/or other grains. In some embodiments, the ration type can also be based on the weight of some or all of the feed animals of the selected set of feed animals and/or the type of feed animal (for example, the breed of cattle).

The weight of each feed animal can be determined either by measurement (e.g., by individually weighing each feed animal), by projection (e.g., calculating a projected weight based on a starting weight and the amount of feed distributed to the feed animal), or by a combination of measurement and projection. Feed animal weights can be stored in the control module 104 and/or the central computer system 112.

In some embodiments, the sequence data can further comprise (iv) a starting ration quantity to be added to the feed container 106. The starting ration quantity can be used to calculate the remaining ration quantity after feed has been dispensed, as described in more detail below.

In some embodiments, the central computer system 112 can receive and store system input data from the control module 104. Using the stored system input data, the central computer system 112 can determine and store an actual feeding sequence undertaken by the dispensing unit. In this way, if the dispensing unit 102 fails to follow the target delivery sequence, target quantity, and target ration type proscribed by the sequence data there is still a record of which feed bunks were fed, what amount was distributed to each, and what type of ration was distributed to each. In some embodiments, the central computer system can receive data from and transmit data to the control module 104 in real time. In other embodiments, the central computer system 112 can send the sequence data as a packet of data prior to an operator using the system 100 and may receive the system inputs as a packet of data after use of the system 100.

In some embodiments, the system 100 further comprises a driving module 126. The driving module 126 can be configured to drive the dispensing unit to a selected location. In some embodiments, a user can use the driving module 126 to drive the dispensing unit 102. In other embodiments, the control module 104 can transmit data to and receive data from the driving module 126 to autonomously drive the dispensing unit 102 based on the sequence data and one or more system inputs. For example, control module 104 can receive sequence data specifying a feed bunk sequence of A, B, C. The control module 104, using driving module 126, can then drive the dispensing unit 102 to feed bunk A using the sequence data and system inputs comprising: (i) location data and (ii) feed bunk identification data. After dispensing feed at feed bunk A, the control module 104 can use the drive module to drive the dispensing unit 102 to feed bunk B and dispense feed, and then on to feed bunk C and dispense feed.

Referring still to FIG. 1, in some embodiments, the system 100 can further comprise a scanning unit 130 configured to transmit data to and receive and store data from the control module 104 and/or the central computer system 112. The scanning unit 130 can comprise a wireless transceiver configured to transmit system inputs to and/or receive system inputs from the control module 104 and/or the central computer system 112. The system inputs can include, for example, feed bunk level data, climate data, and aggressiveness data.

In the illustrated embodiment, the scanning unit 130 is a vehicle separate from the dispensing unit 102. In other embodiments, the scanning unit can be a component mounted on a vehicle (e.g., a land-based or sky-based vehicle), for example, the dispensing unit 102.

In some embodiments, the scanning unit can be configured to drive autonomously. For example, the scanning unit can use a light imaging detection and ranging (LIDAR) scanner to navigate from one feed bunk to another based on one or more inputs such as a feed bunk map and/or a predetermined feed bunk sequence. In other embodiments, the scanning unit can be manually driven, for example, using a control device (e.g., a smartphone, a remote control, a tablet, a computer, etc.). In still other embodiments, the scanning unit can be configured to be driven by a user manually operating the scanning unit, for example, using a steering wheel. Any and all combinations of these devices can also be used.

The scanning unit 130 can comprise a scanner 132 configured to determine the current amount of feed within a feed bunk (e.g., to determine feed bunk level data). For example, the scanner can be a LIDAR scanner. The scanning unit 130 can move along the length of the feed bunk while scanning to determine the amount of feed within the feed bunk. The scanning unit 130 can also be configured to log the time at which it takes measurements, in order to determine at what time the feed is being consumed. This time data can be used to determine history data for a selected feed bunk. The history data can include how much feed was consumed on a selected day (e.g., the previous day) and at what time the feed was consumed.

In some embodiments, as the scanning unit 130 moves along the length of a feed bunk, it can determine the length of the feed bunk. The scanning unit can store the length data either in a local memory unit or in a remote memory. In some embodiments, the control module can calculate the amount of feed in a selected feed bunk based on the length data and the feed bunk level data.

In some embodiments, the system 100 can comprise a first sensor configured to determine climate data. The climate data can include, for example, temperature, barometric pressure, and/or humidity. In some embodiments, the first sensor can be operatively coupled to the scanning unit 130. In other embodiments, the first sensor can be coupled to, for example, the dispensing unit, a feed bunk, a fence, or a tower, and can be configured to transmit climate data to the scanning unit 130, the central computer system 112, and/or the control module 104. In some embodiments, the climate data can be a system-wide input applicable to each feed bunk. In other embodiments, the control module 104 can receive and store climate data for each feed bunk. In such embodiments, each feed bunk can comprise a first sensor.

In some embodiments, the system 100 can comprise a second sensor configured to determine aggressiveness data. Aggressiveness data can include, for example, the time delay between filling a feed bunk with feed and when the feed animals approach the feed bunk to begin eating. Aggressiveness data can be used to determine the target quantity of feed for a selected feed bunk, and also the target time intervals between dispensing feed. In a particular example, the second sensor can be a camera. In some embodiments, the second sensor can be located on the scanning unit. In other embodiments, the second sensor can be located on the dispensing unit 102 and can determine aggressiveness data for feed animals in a selected pen after dispensing feed to the feed bunk associated with that pen. In still other embodiments, each feed bunk can comprise a second sensor configured to determine the aggressiveness data for the feed animals in the pen associated with the respective feed bunk.

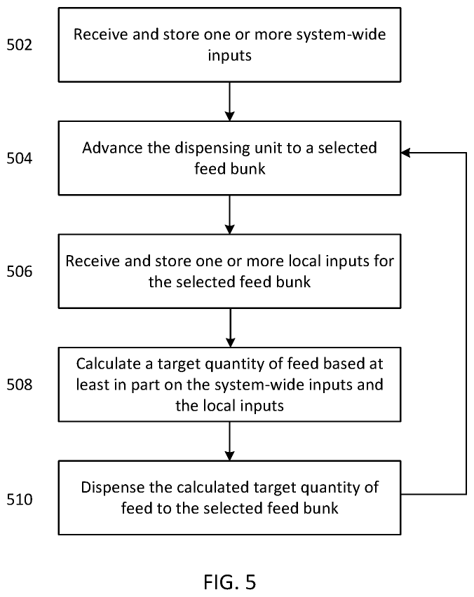

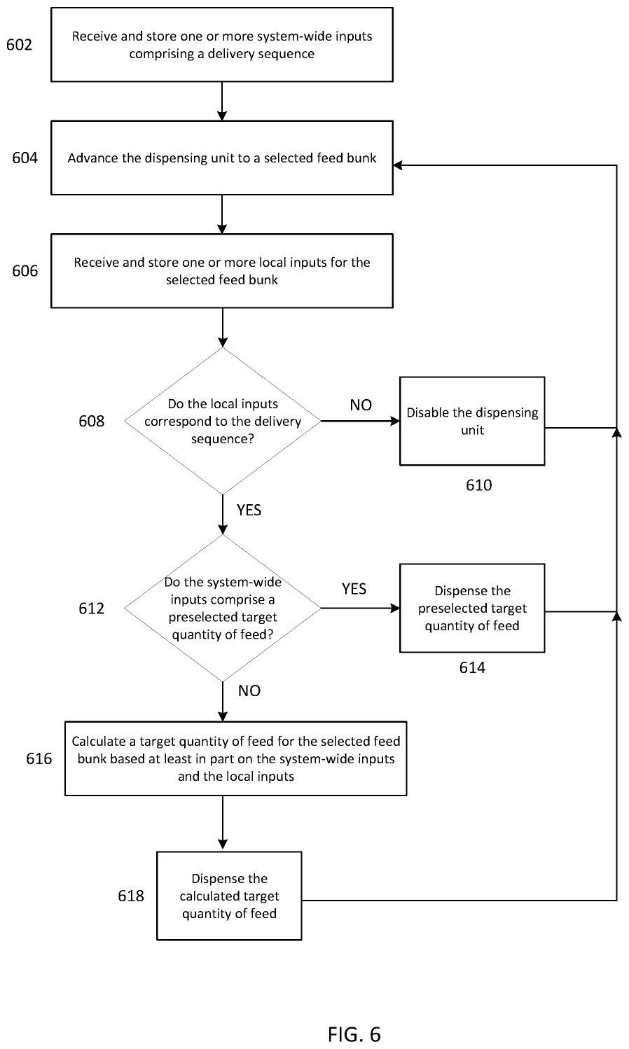

In some embodiments, the second sensor can be an ultra-high frequency (UHF) reader. In such embodiments, each feed animal within a pen can be tagged with a UHF tag. The second sensor can be configured to determine the number of feed animals that approach the feed bunk as feed is dispensed. This data can be sent to the control module 104 and/or the central computer system 112 to develop an aggressiveness algorithm. The aggressiveness algorithm can be used to provide aggressiveness data for a selected feed bunk. The aggressiveness data can be used to determine the target amount of feed to be dispensed to a selected feed bunk, as described with reference to FIGS. 5-6.

As previously mentioned, the system comprises a control module 104 configured to transmit, receive, and/or store various system inputs. As shown in the illustrated embodiment, control module 104 may be located within the dispensing unit 102. For example, control module 104 may be located within the cab 116 of the feed truck 114. In other embodiments, control module 104 may be separate from and in communication with the dispensing unit 102. For example, control module 104 may be a portable or hand-held unit. In such embodiments, control module 104 may communicate wirelessly (e.g., via Wi-Fi, Bluetooth, radio, etc.) with one or more components of dispensing device 102, the central computer system 112, and/or the scanning unit 130.

The control module 104 is configured to (a) receive and store data from the central computer system (e.g., sequence data comprising one or more parameters for distributing feed), (b) receive and store data comprising system inputs from the dispensing unit (e.g., quantity data, ration type data, location data, feed bunk identification data, gate position data, and/or speed data), (c) compare the system inputs to the sequence data, and (d) determine whether the dispensing unit should be disabled.

In a specific example, the control module 104 receives and stores sequence data indicating that the feed bunk sequence is A, B, C. The dispensing unit 102 advances incorrectly to a first feed bunk, for example, feed bunk B. The control module 104 receives and stores system inputs comprising: (i) location data indicating the position of the dispensing unit 102 at feed bunk B and (ii) feed bunk identification data identifying the feed bunk as feed bunk B. The control module 104 compares the location data and the feed bunk identification data to the sequence data and determines that the location data and the feed bunk identification data do not correspond to the given sequence. The control module disables the dispensing unit, preventing feed from being dispensed to incorrect feed bunk B.

In some embodiments, control module 104 can be configured to receive and store history data comprising previously dispensed quantities of feed and previous times that feed was dispensed. The control module 104 can be configured to calculate the target quantity of feed for a selected feed bunk based at least in part on the history data.

In some embodiments, the control module 104 can be further configured to receive and store dwell time data for a selected pen. In some embodiments, dwell time data can be stored in the central computer system 112 and transmitted to the control module 104 when required. Dwell time data can include the length of time a pen has been eating a particular type of feed ration. The control module 104 can be configured to calculate the target quantity for a selected feed bunk based at least in part on the dwell time data.

In some embodiments, the control module 104 is further configured to receive and store data from the scanning unit 130, and to use data received from the scanning unit and/or the central computer system to calculate a target quantity of feed to be distributed to a selected feed bunk.

For example, the control module 104 can receive and store: (i) one or more system-wide inputs; and (ii) one or more local inputs for a selected feed bunk. The control module can then calculate a quantity of feed to be distributed for the selected feed bunk based at least in part on the system-wide inputs and the local inputs, as described below with reference to FIGS. 5-6.

In a specific example, the control module 104 can receive one or more system wide inputs comprising a delivery sequence (e.g., feed bunk A, feed bunk B, feed bunk C), climate data (e.g., temperature, barometric pressure, and/or humidity), and ration type data (e.g., high-energy rations). The system-wide inputs will remain constant or substantially constant (e.g., there may be fluctuations in the climate data) throughout the delivery sequence. The dispensing unit advances to feed bunk A. The control module 104 receives and stores local inputs for feed bunk A, for example, feed bunk identification data, history data, feed bunk level data, dwell time data, feed animal weight data, feed animal type data, and aggressiveness data. The control module 104 compares the feed bunk identification data to the delivery sequence and determines that it corresponds. The control module 104 calculates a target quantity of feed for feed bunk A based at least in part on the system-wide inputs and/or the local inputs. The control module 104 dispenses the target amount of feed to feed bunk A using the dispensing unit 102.

In some embodiments, the control module 104 can further be configured to determine whether the system-wide inputs comprise a preselected target quantity of feed for a selected feed bunk. If the system-wide inputs include a preselected target quantity of feed, the dispensing unit 102 can dispense the preselected target quantity of feed to the selected feed bunk. For example, the first ration fed to a pen in the morning can comprise a preselected quantity of feed. This preselected quantity can be based at least in part on the ration quantities of the previous day.

In some embodiments, all or part of the described system inputs can be generated, tracked, and/or stored using a management program for recording livestock data on an individual feed animal and herd basis and for managing livestock, such as Accu-Trac®. The program can comprise various programs (hereinafter referred to “sub-programs”) configured to provide system inputs to one or more of the control module 104, the central computer system 112, and/or the scanning unit 130. For example, the management program can comprise sub-programs for managing: (i) pharmaceutical inventories; (ii) feed and other consumed products; (iii) monitoring the background, birth, weaning weight, health history, measurements, and performance of an individual feed animal; (iv) providing individual feed animal identification; (v) tracking and trace-back through supply chains; (vi) feed animal age; (vii) feed animal source; and (viii) National Animal Identification System (NAIS) requirements. Such programs and sub-programs can be configured to provide system inputs when required to calculate a target quantity of feed.

The control module 104 can comprise a wireless data transceiver. In some embodiments, the wireless data transceiver can be configured to receive and transmit data between the control module 104 and one or more of: (i) the central computer system 112; (ii) the quantity indicator 110; (iii) each feed bunk; (iv) the dispensing device 108; (v) the location unit 118; (vi) the speed indicator 120; (vii) the gate position indicator 124; (viii) the driving module 126; (ix) the scanning unit 130; or (x) any combination thereof. Suitable transceivers include, but are not limited to, a wireless transceiver that transmits and receives radio waves within a frequency band of 2.4 GHz or 5 GHz, an ultra-high frequency radio wave transceiver that transmits and receives radio waves within a frequency band of from 2.4 to 2.485 GHz, or a free-space optical communication transceiver, and combinations thereof.

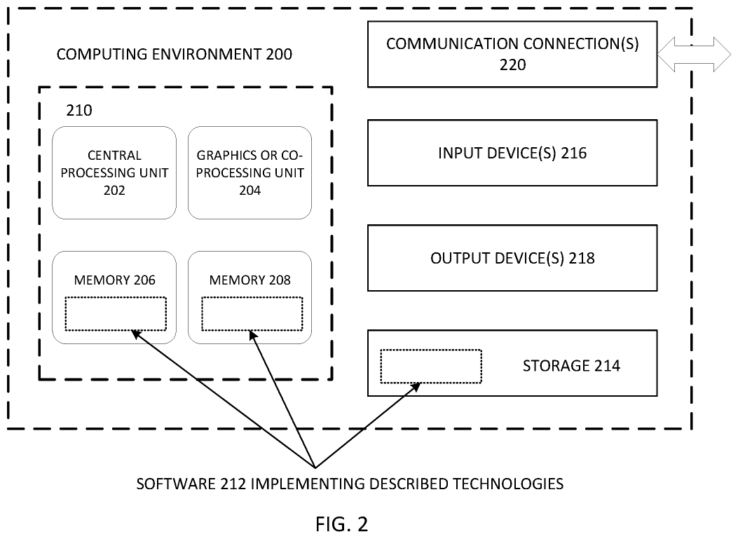

The following is a general description of a computing environment suitable for use with the disclosed control module 104. FIG. 2 depicts a generalized example of a suitable computing environment 200 in which software and control algorithms for the described innovations may be implemented. The computing environment 200 is not intended to suggest any limitation as to scope of use or functionality, as the innovations may be implemented in diverse general-purpose or special-purpose computing systems. For example, the computing environment 200 can be any of a variety of computing devices (e.g., desktop computer, laptop computer, server computer, tablet computer, gaming system, mobile device, programmable automation controller, etc.).

With reference to FIG. 2, the computing environment 200 includes one or more processing units 202, 204 and memory 206, 208 (e.g., for storing sequence data and/or system input data). In FIG. 2, this basic configuration 210 is included within a dashed line. The processing units 202, 204 execute computer executable instructions. A processing unit can be a general-purpose central processing unit (CPU), a processor in an application-specific integrated circuit (ASIC), or any other type of processor. In a multi-processing system, multiple processing units execute computer-executable instructions to increase processing power. For example, FIG. 2 shows a central processing unit 202 as well as a graphics processing unit 204. The tangible memory 206, 208 can be volatile memory (e.g., registers, cache, RAM), non-volatile memory (e.g., ROM, EEPROM, flash memory, etc.) or some combination of the two, accessible by the processing unit(s). The memory 206, 208 stores software 212 implementing one or more innovations described herein, in the form of computer-executable instructions suitable for execution by the processing unit(s).

A computing system may have additional features. For example, in some embodiments, the computing environment 200 includes storage 214, one or more input devices 216, one or more output devices 218, and one or more communication connections 220. An interconnection mechanism (not shown) such as a bus, controller, or network, interconnects the components of the computing environment 200. Typically, operating system software (not shown) provides an operating environment for other software executing in the computing environment 200, and coordinates activities of the components of the computing environment 200.

The tangible storage 214 may be removable or non-removable, and includes magnetic disks, magnetic tapes or cassettes, CD-ROMs, DVDs, or any other medium that can be used to store information in a non-transitory way and can be accessed within the computing environment 200. The storage 214 stores instructions for the software 212 implementing one or more innovations described herein (e.g., for storing sequence data, quantity data, ration type data, location date, etc.).

The input device(s) 216 can be, for example: a touch input device, such as a touchscreen display, keyboard, mouse, pen, or trackball; a voice input device; a scanning device; any of various sensors (e.g., the quantity indicator, speed indicator, location unit, etc.); another device that provides input to the computing environment; or combinations thereof. The output device(s) 218 can be a display, printer, speaker, CD-writer, transmitter, or another device that provides output from the computing environment 200.

The communication connection(s) 220 enable communication over a communication medium to another computing entity. For example, the communication connection(s) can enable communication between the control module 104 and the central computer system 112. The communication medium conveys information, such as computer-executable instructions or other data in a modulated data signal. A modulated data signal is a signal that has one or more of its characteristics set or changed in such a manner as to encode information in the signal. By way of example, and not limitation, communication media can use an electrical, optical, RF, or other carrier.

Any of the disclosed methods can be implemented as computer-executable instructions stored on one or more computer-readable storage media (e.g., one or more optical media discs, volatile memory components (such as DRAM or SRAM), or nonvolatile memory components (such as flash memory or hard drives)) and executed on a computer (e.g., any commercially available computer, including smart phones, other mobile devices that include computing hardware, or programmable automation controllers). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C, C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc., or combinations thereof.

Furthermore, any of the software-based embodiments (comprising, for example, computer-executable instructions for causing a computer to perform any of the disclosed methods) can be uploaded, downloaded, or remotely accessed through a suitable communication means. Such suitable communications means include, for example, the Internet, the World Wide Web, an intranet, software applications, cable (including fiber optic cable), magnetic communications, electromagnetic communications (including RF, microwave, and infrared communications), electronic communications, other such communication means, or combinations thereof.

Operation of the dispensing unit 102 components to dispense feed is controlled by control module 104. For example, control module 104 can control the one or more dispensing devices 108, including activating/disabling the devices and regulating the rate of feed being dispensed. In embodiments wherein the dispensing devices 108 are movable devices (e.g., an auger or a rotary valve), the control module can, for example, control the speed of rotation of the dispensing device. In some embodiments, the operation of the control module 104 to control the dispensing unit 102 can be controlled by a user. In other embodiments, control module 104 can autonomously control the dispensing unit 102 based on received data (e.g., the sequence data and one or more system inputs).

In lieu of or in addition to controlling dispensing unit 102, control module 104 can be configured to provide alerts. For example, such alerts could include: (i) system inputs fail to correspond to the sequence data, and/or (ii) when a system input is near failing to correspond to the sequence data (e.g., within 10%). For example, control module 104 can be configured to provide an alert if the type of ration loaded into feed container 106 fails to correspond to the type of feed ration specified in the sequence data. In another example, control module 104 can be configured to provide an alert when the amount of feed distributed to a feed bunk is within 10% of the target amount of feed specified by the sequence data. An alert or alarm can be, for example, a visual alert, an audible alert, or a tactile alert such as a vibration.

In some embodiments, the system 100 can further include a display 128. For example, the display 128 can be included within the cab 116 of the feed truck 114. In another example, the display 128 can be located on a laptop, tablet, handheld, and/or mobile device. The display 128 can be configured to display a user interface (UI) comprising one or more data outputs from the control module 104. In some embodiments, the display 128 can be a touchscreen display/UI and is configured to accept user input(s). The display 128 can have any configuration suitable to display one or more of: (i) sequence data information; (ii) system input information; (iii) instructions to a user; (iv) alerts/alarms; or (v) any combination thereof. In some embodiments, the display 128 can be configured such that a user can input data to the control module 104 via the display, as discussed in more detail below.

In a particular example, the control module 104 can be configured to disable the dispensing unit 102 and generate an alert on display 128 if the location data fails to correspond to the target sequence provided by the sequence data. A user can acknowledge the alert, for example, by pressing ‘OK’ or ‘Cancel.’ If the user presses ‘OK,’ the control module generates a manual entry screen wherein the user can enter a manual feed bunk identification number. If the manual feed bunk identification number corresponds to the sequence data, the dispensing unit can be enabled to dispense feed. However, the control module 104 will send an alert to the central computer system 112 such that the location data/sequence data mismatch can be logged and accounted for. If the user enters a manual feed bunk identification number that fails to correspond to the sequence data, the control module 104 can disable the dispensing unit 102, preventing feed from being distributed to the feed bunk. If the user presses ‘Cancel,’ the control module can remove the alert, returning the user to the previous screen and allowing the dispensing unit to proceed.

### III. Method of Dispensing Feed

With reference to FIG. 1, system 100 comprising control module 104 and dispensing unit 102 can be used to dispense feed in the following exemplary manner. Control module 104 receives and stores sequence data identifying one or more target system parameters. The target system parameters can comprise: (i) a target delivery sequence specifying a sequence in which the feed bunks are to be filled; and/or (ii) a target ration type for each feed bunk. The target system parameters can also optionally include (iii) a preselected target quantity for each feed bunk. The feed container 106 of dispensing unit 102 can be filled with a feed ration load. The control module 104 can receive a first set of system inputs comprising information about one or more variables within the system 100. Dispensing unit 102 can proceed to a first feed bunk. Control module 104 can receive a second set of system inputs comprising information about one or more variables within the system 100. The control module 104 can compare the first and second sets of system inputs to the sequence data. If one or more system inputs do not correspond to the sequence data, the control module 104 disables the dispensing unit 102, preventing it from dispensing feed.

The first and second sets of system inputs can comprise system-wide and/or local inputs, for example: (i) feed type data identifying a feed type within feed container 106; (ii) quantity data identifying the amount of feed within feed container 106; (iii) location data identifying the location of the dispensing unit 102; (iv) feed bunk identification data identifying a current feed bunk (e.g., the nearest feed bunk, which can be identified via, for example, a set of GPS coordinates, a RFID tag, a user input, or other means of identification); (v) speed data identifying a speed at which the dispensing unit 102 is travelling; (vi) gate position data identifying the position of gate 122, or (vii) any combination thereof.

In some embodiments, control module 104 can be configured to receive a set of system-wide inputs for all feed bunks and a set of local inputs for each feed bunk. The control module 104 can be configured to determine the target quantity of feed to be delivered to a selected feed bunk based at least in part on system-wide inputs and the local inputs. In some embodiments, the system-wide inputs can comprise some or all of the first and second sets of system inputs defined above as well as additional system-wide inputs. For example, the system-wide inputs can comprise: (i) delivery sequence data; (ii) ration type data; and (iii) climate data. In some embodiments, the local inputs can comprise some or all of the first and second sets of inputs described above as well as additional local inputs. For example, the local inputs can comprise: (i) feed bunk identification data; (ii) history data; (iii) dwell time data; (iv) feed animal weight data; (v) feed animal type data; (vi) feed bunk level data; and (vii) aggressiveness data. The control module 104 can determine a target quantity of feed to be dispensed to a selected feed bunk based at least in part on the system-wide inputs and the local inputs.

In some embodiments, if any one system input fails to correspond to the sequence data, the control module 104 disables the dispensing unit 102. In other embodiments, more than one system input must fail to correspond to the sequence data in order for the control module to disable the dispensing unit. For example, in some embodiments, if both the location data and the feed bunk identification data do not correspond to the sequence data, the control module 104 will disable the dispensing unit 102. In some embodiments, the system inputs can be given priority rankings, such that if a high priority system input (e.g., a system input in the second set of system inputs) does not correspond to the sequence data the control module 104 will disable the dispensing unit 102, but if a low priority system input (e.g., a system input in the first set of system inputs) does not correspond to the sequence data the control module 104 will not disable the dispensing unit 102 unless another low priority system input fails to correspond and/or a high priority system input fails to correspond to the sequence data. The high/low priority designation can be applied to any set of inputs (e.g., the first set of system inputs can be high priority and the second set can be low priority or vice versa, or the local inputs can be high priority and the system wide inputs can be low priority, or vice versa), or priority designations can be applied to individual inputs within a set (e.g., feed bunk identification data can be given the highest priority). Priority designations can be dictated within the sequence data for particular feed runs. In some embodiments, system inputs belonging to the first set of system inputs are high priority inputs and system inputs belonging to the second set of system inputs and/or the additional set of system inputs are low priority inputs.

The control module 104 can disable the dispensing unit by deactivating and/or preventing the activation of the one or more dispensing devices 108. In some embodiments, the control module 104 can disable the dispensing unit by closing the gate 122, or by preventing the gate 122 from opening.

In a particular embodiment, the sequence data can comprise, for example: (i) a target feed bunk filling order of A, B, C; (ii) a target quantity of 600 lbs. of feed for each feed bunk; and (iii) a target ration type of grain. The dispensing unit 102 can advance to a filling station, wherein the feed container 106 is filled with grain. The control module can receive a first set of system inputs comprising, for example: (i) feed type data identifying the feed as grain; and (ii) quantity data identifying the amount of feed within the feed container (e.g., 2,000 lbs.). The dispensing unit 102 advances incorrectly to a first feed bunk, for example, feed bunk C. At or adjacent the first feed bunk, the control module receives a second set of system inputs comprising, for example: (iii) location data identifying that the dispensing unit 102 is located at feed bunk C; and (iv) feed bunk identification data indicating that the feed bunk is feed bunk C. The control module compares the sequence data to the system inputs and finds that they do not correspond. The control module 102 disables the dispensing unit 104, preventing incorrect distribution of feed to feed bunk C.

The sequence data may can comprise a target delivery sequence, a target quantity (e.g., the target quantity can be a preselected target quantity or a calculated target quantity based at least in part on the system inputs), a target ration type, or any combination thereof. In some embodiments, the control module 104 can receive only the system inputs that correspond to the sequence data. For example, if only (i) a target delivery sequence is specified by the sequence data, the control module 104 can optionally receive only system inputs comprising (iii) location data identifying the location of the dispensing unit 102 and (iv) feed bunk identification data identifying the current feed bunk. In another example, if the sequence data specifies only (ii) a target quantity of feed, the control module 104 can optionally receive only system inputs comprising (ii) quantity data specifying the amount of feed in the feed container 106.

In embodiments wherein the sequence data specifies a target ration type, the control module 104 can receive a system input comprising ration type data for the feed within the feed container 106 in one of the following exemplary manners. In some embodiments, the ration type data can be received from the central computer system 112 and/or the scanning unit 130. For example, the target ration type provided by the sequence data can also function as the system input comprising ration type data. The control module 104 can receive an attempt to transmit the sequence data and can generate a prompt prompting the user to either accept or deny the transmission of the sequence data. If the user accepts the sequence data, the control module 104 can receive the target ration type both as part of the sequence data and as the system input comprising ration type data. In other embodiments, the ration type data can be entered manually by a user, for example, using touchscreen display 128. In still other embodiments, the ration type data can be determined automatically based on the location of the dispensing unit when the feed container 106 is filled (e.g., the location of each filling station can correspond to a specific ration type).

In some embodiments, the sequence data may specify a target quantity of feed for one or more feed bunks (e.g., a preselected target quantity). In other embodiments, the target quantity of feed for a selected feed bunk may be calculated using an algorithm, as described in more detail below. In embodiments wherein the sequence data specifies a preselected target quantity, the control module 104 can receive a system input comprising target quantity data from the dispensing unit 102 and/or the central computer system 112. The quantity data can comprise, for example, a starting amount, a current amount, and a dispensed amount. The quantity indicator can provide quantity data for the feed within the feed container 106 in the following exemplary manner. The feed container 106 can be filled with a starting amount of feed ration. The quantity of feed ration within the feed container 106 can be determined by the quantity indicator 110 (e.g., a load cell) which provides the starting amount to the control module 104. As feed is dispensed, the quantity indicator 110 provides real-time quantity data (i.e., a current amount) to the control module 104. Using subtractive measurement, the control module 104 compares the starting amount to the current amount and determines the amount of feed that has been distributed to the feed bunk (i.e., the dispensed amount). During the dispensing process, the control module 104 can continuously compare the quantity data with the target quantity identified by the sequence data. If the target quantity is exceeded, the control module 104 disables the dispensing unit 102, preventing the further distribution of feed.

For example, the sequence data can comprise a target quantity of 600 lbs. of feed per feed bunk and the feed container 106 can be filled with a starting quantity of 2,000 lbs. of feed. If the quantity indicator 110 provides a current feed amount of 1,350 lbs., using subtractive measurement (2,000 lbs.-1,350 lbs.=650 lbs.) the control module 104 compares the system input comprising the quantity data (the distributed amount: 650 lbs.) to the target quantity specified by the sequence data (600 lbs.), determines that the system input does not correspond to the sequence data, and disables the dispensing unit 102.

In some embodiments, the sequence data can also comprise an acceptable derivation from the target quantity identified by the sequence data. In such embodiments, the control module 104 will not disable the dispensing unit 102 until the distributed amount exceeds, for example, the upper limit of the acceptable derivation.

In some embodiments, the method further comprises using the control module 104 to control the rate of feed distribution such that feed is evenly distributed along the length of the feed bunk without exceeding the target quantity of feed specified by the sequence data. The control module 104 can receive system inputs comprising (i) speed data indicating a speed of the dispensing unit 102, (ii) gate position data indicating the position of gate 122, and (iii) quantity data indicating an amount of feed dispensed from feed container 106. Using these inputs the control module 104 can regulate the speed of the dispending unit 102 (e.g., using driving module 126) and/or the position of the gate 122, such that the amount of feed dispensed per feed bunk does not exceed (overfeeding) or fail to meet (underfeeding) the target quantity specified by the sequence data.

In some embodiments, rather than having the control module 104 regulate the speed of the dispensing unit and/or the position of the gate, the control module 104 is configured to provide a display using display 128 that indicates the rate of feed distribution, the remaining feed within the feed container, and the amount of feed distributed. If the control module 104 determines that the rate of feed distribution will result in either underfeeding or overfeeding, the control module provides an alert to the user. The user may then adjust the speed and/or the gate position of the dispensing unit 102.

In some embodiments, the method further comprises allowing a user to override either an alert provided by the control module 104, or the disabling of the dispensing device 102 by the control module 104. In such embodiments, if a system input fails to correspond to the sequence data, a user can manually override the non-corresponding input, allowing the dispensing unit 102 to dispense feed as required. For example, if the feed bunk identification data incorrectly identifies the feed bunk, causing a system input-sequence data mismatch, a user can manually input the feed bunk identification number and allow the system 100 to dispense feed. In such embodiments, the manual feed bunk identification entry by an operator can generate an alert sent to the central computer system 112.

In some embodiments, the method can further comprise allowing the control module 104 to autonomously drive the dispensing unit 102 and dispense feed based on received sequence data and one or more system inputs. In such embodiments, the control module 104 can control driving module 126 which is configured to control the movement of the dispensing unit 102.

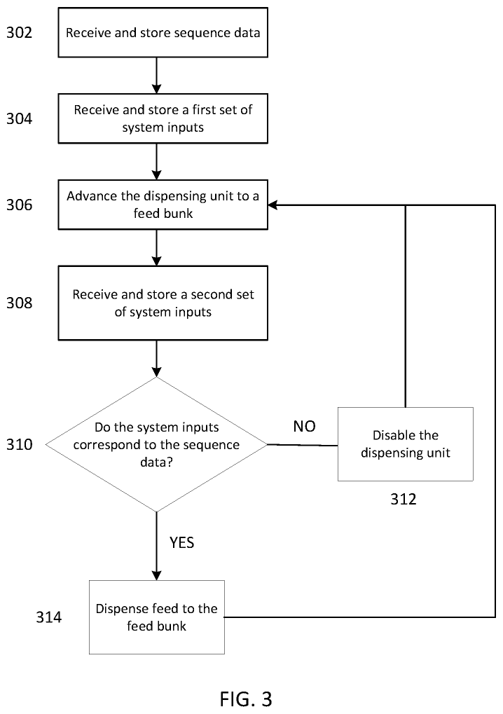

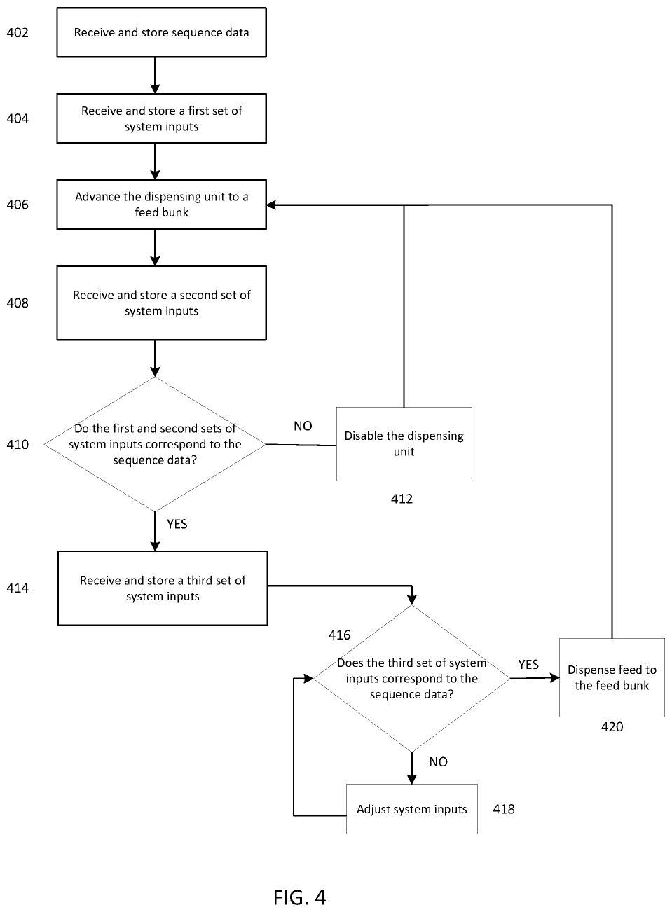

FIGS. 3-4 are flow diagrams showing aspects of exemplary computer algorithms for accurately dispensing feed rations using embodiments of the disclosed system. While exemplary aspects of the algorithms are shown, it will be understood that some steps may be optional and some functions may be performed in an alternate but comparable manner.

Referring now to FIG. 3, in some embodiments, the algorithm is activated when the system (e.g., system 100) receives and stores sequence data for dispensing feed (302). The sequence data can comprise, for example, a target sequence, a target quantity, and a target feed type. A first set of system inputs is received and stored (304). The first set of system inputs can comprise, for example, feed type data (e.g., entered manually by a user), and quantity data. The dispensing unit then advances to a feed bunk (306) and a second set of system inputs is received and stored (308). The second set of system inputs can comprise location data and feed bunk identification data. The algorithm can then query whether the system inputs correspond to the sequence data (310). If the system inputs correspond to the sequence data, the algorithm enables the system to dispense feed to the feed bunk (314) and the algorithm repeats steps (306-310). If the system inputs fail to correspond to the sequence data, the algorithm disables the dispensing unit (312), preventing it from dispensing feed, and repeats steps (306-310).

With reference to FIG. 4, in some embodiments the algorithm can comprise additional process steps. For example, the algorithm can be activated when the system (e.g., system 100) receives and stores sequence data comprising, for example, a target sequence, a target quantity, and a target feed type (402). A first set of system inputs comprising, for example, feed type data and quantity data, is received and stored (404). The dispensing unit can then advance to a feed bunk (406) and receive and store a second set of system inputs (408) comprising, for example, location data and feed bunk identification data. The algorithm can then query whether the first and second sets of system inputs correspond to the sequence data (410). If the first and second sets of system inputs fail to correspond to the sequence data, the algorithm disables the dispensing unit (412), preventing it from dispensing feed, and repeats steps (406-410). If the first and second sets of system inputs correspond to the sequence data, a third set of system inputs can be received and stored (414). The third set of system inputs can comprise speed data and gate position data. The algorithm can then query whether the third set of system inputs corresponds to the sequence data (416). If the third set of system inputs corresponds to the sequence data, the algorithm enables the system to dispense feed to the feed bunk (420). If the third set of system inputs does not correspond to the sequence data, one or more system inputs of the third set of system inputs are adjusted (418). For example, the speed of the dispensing unit can be adjusted (e.g., manually by an operator or automatically via the control module 104) and/or the gate position can be adjusted (e.g., manually by an operator or automatically via the control module 104). After adjustment, the algorithm repeats step (416) and queries whether the third set of system inputs correspond to the sequence data. If no, steps (418-416) are repeated until the system inputs correspond to the sequence data and the algorithm enables the system to dispense feed to a feed bunk (420).

Referring now to FIGS. 5-6, in some embodiments, the target quantity of feed to be dispensed to a selected feed bunk can be calculated using an algorithm. The algorithm can use one or more system-wide inputs and/or local inputs to determine the target quantity of feed to be dispensed.

FIG. 5 is a flow diagram showing aspects of an exemplary computer algorithm for determining a target quantity of feed to be distributed by the dispensing unit to a selected feed bunk and dispensing the feed. While exemplary aspects of the algorithm are shown, it will be understood that some steps may be optional and some functions may be performed in an alternate but comparable manner.

In some embodiments, the algorithm is activated when the system (e.g., system 100) receives and stores one or more system-wide inputs (502). The system wide inputs can comprise, for example, delivery sequence data, ration type data, and/or climate data. The dispensing unit then advances to a selected feed bunk (504) and one or more local inputs are received and stored for the selected feed bunk (506). The local inputs can comprise, for example, history data, dwell time data, feed animal weight data, feed animal type data, feed bunk level data, aggressiveness data, and feed bunk identification data. The control module can then calculate a target quantity of feed based in part on the system-wide inputs and the local inputs (508). The dispensing unit can then dispense the calculated target quantity of feed to the selected feed bunk (510). The dispensing unit can then repeat steps (504-510) until each feed bunk has been filled.

With reference to FIG. 6, in some embodiments the algorithm can comprise additional process steps. For example, the algorithm can be activated when the system (e.g., system 100) receives and stores at least one system-wide input comprising a delivery sequence (602). The dispensing unit can then be advanced to a selected feed bunk (604) and one or more local inputs can be received and stored for the selected feed bunk (606). The algorithm can then query whether the local inputs correspond to the delivery sequence (608). If the local inputs do not correspond to the delivery sequence (e.g., indicating that the dispensing unit is at the wrong feed bunk and/or is carrying the incorrect feed, etc.), the dispensing unit can be disabled (610) and the dispensing unit can then advance to a subsequent selected feed bunk (604) at which point steps (604-608) can be repeated. If the local inputs do correspond to the delivery system (e.g., indicating that the dispensing unit is located at the correct feed bunk and has the correct feed etc.), the algorithm can query whether the system-wide inputs comprise a preselected target quantity of feed (612). For example, for the first feed of the day, a preselected target quantity of feed may be used rather than a calculated target quantity. If the system-wide inputs do comprise a preselected target quantity of feed, the dispensing unit can dispense the preselected target quantity of feed to the selected feed bunk (614) at which point steps (604-608) can be repeated. If the system-wide inputs do not comprise a preselected target quantity of feed, the algorithm can calculate a target quantity of feed for the selected feed bunk based at least in part on the system-wide inputs and the local inputs (616). The dispensing unit can then dispense the calculated target quantity of feed to the selected feed bunk (618) at which point steps (604-608) can be repeated.

In view of the many possible embodiments to which the principles of the disclosure may be applied, it should be recognized that the illustrated embodiments are only preferred examples and should not be taken as limiting the scope of the disclosure. Rather, the scope of the disclosure is defined by the following claims. We therefore claim all that comes within the scope and spirit of these claims.

We claim:

1. A system, comprising:
a dispensing unit comprising a feed container and one or more dispensing devices configured to dispense feed from the feed container; and
a control module operatively configured to disable the dispensing unit from dispensing feed.

2. The system of claim 1, wherein the dispensing unit further comprises a quantity indicator configured to measure a quantity of feed within the feed container.

3. The system of claim 2, wherein the control module is configured to receive and store sequence data from a central computer system and one or more system inputs, the sequence data comprising a delivery sequence in which one or more feed bunks are to be filled, a quantity of feed for each feed bunk, a ration type for each feed bunk, or any combination thereof.

4. The system of claim 3, wherein the system inputs comprise at least one of location data identifying a location of the dispensing unit, feed bunk identification data for one or more feed bunks, ration type data for feed in the feed container, and quantity data from the quantity indicator.

5. The system of claim 3, wherein the control module is configured to compare the sequence data to the one or more system inputs and disable the dispensing unit if the one or more system inputs do not correspond to the sequence data.

6. A system, comprising:
a dispensing unit comprising a feed container and one or more dispensing devices operatively coupled to the feed container to dispense feed from the feed container;
a control module in communication with the dispensing unit and configured to receive and store (a) sequence data from a central computer system, the sequence data comprising a delivery sequence according to which one or more feed bunks are to be filled, and (b) one or more system inputs, the one or more system inputs comprising location data identifying a location of the dispensing unit and feed bunk identification data for the one or more feed bunks; and
wherein the control module is configured to disable the dispensing unit if any system input does not correspond to the sequence data.

7. The system of claim 6, wherein the dispensing unit further comprises a quantity indicator operatively coupled to the feed container, and wherein an additional system input comprises quantity data from the quantity indicator.

8. The system of claim 6, wherein an additional system input comprises ration type data identifying a type of feed ration in the feed container.

9. The system of claim 6, wherein the control module is configured to activate the one or more dispensing devices such that a feed ration is dispensed to a feed bunk if the one or more system inputs correspond to the sequence data.

10. The system of claim 6, wherein the dispensing unit further comprises:
a gate operatively coupled to the feed container;
a gate position indicator configured to provide gate position data; and
a speed indicator configured to provide speed data.

11. The system of claim 10, wherein the control module controls the gate position and speed of the dispensing unit based at least in part on the gate position data and the speed data.

12. The system of claim 6, wherein the control module transmits the system inputs in real-time to the central computer system.

13. The system of claim 6, further comprising a driving module operatively coupled to the dispensing unit and in communication with the control module, wherein the control module uses the driving module to autonomously drive the dispensing unit based on the sequence data and the system inputs.

14. A system, comprising:
a dispensing unit comprising (a) a feed container to receive feed, (b) one or more dispensing devices operatively coupled to the feed container to dispense feed from the feed container, (c) a quantity indicator operatively coupled to the feed container to measure a quantity of feed within the feed container and provide quantity data, (d) a location unit to determine a location of the dispensing unit and provide location data, (e) a speed indicator to determine a speed of the dispensing unit and provide speed data, (f) a gate operatively coupled to the feed container, the gate having a gate position movable between an open position wherein feed can be distributed and a closed position to prevent feed distribution, (g) a gate position indicator operatively coupled to the gate to provide gate position data; and
a control module in communication with the dispensing unit and configured to (a) receive and store sequence data from a central computer system, the sequence data comprising: a delivery sequence in which one or more feed bunks are to be filled, a quantity of feed for each of the one or more feed bunks, and a ration type for each of the one or more feed bunks, (b) receive and store one or more system inputs, the system inputs comprising: location data, feed bunk identification data for one or more feed bunks, quantity data, ration type data for feed in the feed container, speed data for the dispensing unit, and gate position data, (c) transmit the system inputs in real-time to the central computer system, (d) adjust the gate position and speed based on the system inputs, (e) activate the one or more dispensing devices if the system inputs correspond to the sequence data, and (f) disable the dispensing devices if system inputs do not correspond to the sequence data.

15. A system, comprising:
a dispensing unit comprising a feed container to receive feed, one or more dispensing devices operatively coupled to the feed container to dispense feed from the feed container to one or more feed bunks, a quantity indicator operatively coupled to the feed container to measure the quantity of feed within the feed container and provide quantity data, a location unit to determine a location of the dispensing unit and provide location data;
a scanning unit comprising a scanner to determine feed bunk level data;
a control module in communication with the dispensing unit and the scanning unit and configured to:
(a) receive and store one or more system-wide inputs from at least one of a central computer system and the scanning unit, the system-wide inputs comprising a delivery sequence and a ration type;
(b) advance the dispensing unit to a selected feed bunk based at least in part on the delivery sequence;
(c) receive and store one or more local inputs for the selected feed bunk;
(d) calculate a target quantity of feed for the selected feed bunk based at least in part on the system-wide inputs and the local inputs;
(e) dispense the calculated target quantity of feed to the selected feed bunk.

16. The system of claim 15, wherein the system-wide inputs further comprise climate data comprising one or more of temperature, barometric pressure, and humidity.

17. The system of claim 15, wherein the local inputs comprise at least one of feed bunk identification data, history data, dwell time data, feed animal weight data, feed animal type data, feed bunk level data, and aggressiveness data.

18. The system of claim 17, further comprising a UHF reader configured to provide UHF data, wherein the aggressiveness data is determined by an algorithm based at least in part on the UHF data.

19. The system of claim 15, wherein the scanner is a LIDAR scanner.

20. The system of claim 15, wherein the scanning unit further comprises a first sensor to determine climate data.

21. The system of claim 15, wherein the scanning unit further comprises a second sensor to determine aggressiveness data.

22. A method, comprising:
providing the system of claim 1; and
using the system.

23. The method of claim 22, wherein using the system comprises:
receiving and storing, using the control module, sequence data from a central computer system for one or more feed bunks, the sequence data comprising a delivery sequence in which the one or more feed bunks are to be filled, a quantity of feed for each of the one or more feed bunks, and a ration type for each of the one or more feed bunks;
receiving and storing, using the control module, one or more system inputs, the system inputs comprising quantity data and ration type data for feed in the dispensing unit;
advancing the dispensing unit to a feed bunk;
receiving, using the control module, additional system inputs comprising location data identifying a location of the dispensing unit and feed bunk identification data for the feed bunk;
comparing, using the control module, the system inputs to the sequence data; and
disabling, using the control module, the dispensing unit if the system inputs do not correspond to the sequence data.

24. The method of claim 23, wherein disabling the dispensing unit comprises disabling the dispensing unit if at least one system input does not correspond to the sequence data.

25. The method of claim 23, further comprising dispensing a feed ration to the feed bunk if the system inputs correspond to the sequence data.

26. The method of claim 23, further comprising:
receiving, using the control module, additional system inputs comprising speed data for the dispensing unit and gate position data for a gate of the dispensing unit; and
controlling, using the control module, a position of the gate based on the system inputs.

27. The method of claim 26, further comprising:
controlling, using the control module, a location of the dispensing unit and a speed of the dispensing unit; and
dispensing a first feed ration to the feed bunk if the system inputs correspond to the sequence data.

28. The method of claim 23, further comprising repeating the acts of advancing the dispensing unit to a feed bunk;
receiving, using the control module, system inputs comprising location data for the dispensing unit and identifying data for the feed bunk;
comparing, using the control module, system inputs to the sequence data; and
disabling, using the control module, the dispensing unit if the system inputs do not correspond to the sequence data.

29. The method of claim 28, further comprising
manually entering a manual feed bunk identification into the control module;
comparing, using the control module, the manual feed bunk identification to the sequence data; and
disabling, using the control module, the dispensing unit if the manual feed bunk identification does not correspond to the sequence data.

30. A method, comprising making a system according to claim 1.

31. A method, comprising:
providing the system of claim 15; and
using the system.
